(19) United States
(12) Patent Application Publication
(10) Pub. No.: US 2026/0147801 A1
(43) Pub. Date: May 28, 2026

(54) METHOD AND SYSTEM FOR GENERATING DATA REPRESENTATIONS BASED ON LARGE LANGUAGE MODELS

(71) Applicant: 42Maru Inc., Seoul (KR)

(72) Inventors: Dong Hwan KIM, Seoul (KR); Han Soo KIM, Bucheon-si (KR); Woo Tae JEONG, Seongnam-si (KR); You Kyung KWON, Seoul (KR); Min Kyung KIM, Namyangju-si (KR); Gil Je SEONG, Goyang-si (KR); Min U JUNG, Seoul (KR)

(73) Assignee: 42Maru Inc., Seoul (KR)

(21) Appl. No.: 19/396,784

(22) Filed: Nov. 21, 2025

(30) Foreign Application Priority Data
Nov. 22, 2024 (KR) 10-2024-0168156

(51) Int. Cl. G06F 16/3329; G06F 16/3332; G06F 16/338; G06F 40/284; G06F 40/30

(52) U.S. Cl. CPC G06F 16/33295; G06F 16/3338; G06F 16/338; G06F 40/284; G06F 40/30

(57) ABSTRACT

A method for providing a response to a user query includes analyzing intent of a natural language query, making a request for a format of a table and/or a chart according to the intent of the natural language query to the LLM when the intent of the natural language query includes a response in a form of the table and/or the chart, determining whether a response in a form of a table and/or a chart is possible, based on whether data required from the format is capable of being found from the user data or is capable of being computed from the user data, generating, by the LLM, a response to the natural language query in the form of the table and/or the chart based on the user data when the response is possible, and providing the user with the data as a data source together with the response.

### CROSS-REFERENCE TO RELATED APPLICATIONS

This application claims priority under 35 U.S.C. § 119 to Korean Patent Application No. 10-2024-0168156 filed on Nov. 22, 2024, in the Korean Intellectual Property Office, the disclosures of which are incorporated by reference herein in their entireties.

### BACKGROUND

Embodiments of the present disclosure described herein relate to a method and a system for generating data representations based on a large language model (hereinafter referred to as “LLM”), and more particularly, relate to a method and a system for recognizing unstructured data within a document by using an LLM and generating data representations such as tables and/or charts based on the document.

Enterprise-specific small language model (sLLM) systems are designed to provide services focused on processing enterprise-specific requirements and creating business values by using language models specialized for enterprise environments. Compared to general LLM services, the enterprise-specific sLLM systems have key requirements: security to protect sensitive enterprise information, domain specialization tailored to specific industries or enterprise needs, seamless integration with conventional enterprise systems and workflows, and scalability with another system of an enterprise.

The sLLM systems are recently evolving to effectively integrate and analyze diverse data sources within an enterprise, thereby providing business insights. In particular, a function is being emphasized such that a user asks questions in a natural language on conversational interfaces and performs complex business queries, and even non-technical employees easily analyze data and gain insights. For example, document summarization, report creation, and dashboard creation functions are being specifically emphasized, and they are evolving into tools that support decision-making.

Within the enterprise-specific sLLM services, responses to natural language queries on interactive interfaces are provided based on enterprise data. However, the enterprise data includes not only structured data like JSON and RDBMS but also a significant amount of unstructured data such as tables, charts, and images. Accordingly, LLM researches focus on improving the accuracy of recognizing and reasoning about the unstructured data, and providing business insights, which are demanded by enterprise users, in the form of data representations, such as tables and charts that are suitable for the intent of queries of a user.

### SUMMARY

Embodiments of the present disclosure provide a method and a system for generating data representation based on an LLM with high accuracy in recognition and inference of unstructured data of a company.

Embodiments of the present disclosure provide a method and a system for generating data representations in the form of tables and charts that reflect the intent of queries of enterprise users.

Embodiments of the present disclosure provide a method and a system for increasing the accuracy of a response of sLLM for enterprises and simultaneously ensuring data reliability for the response by separating a process of generating a format for a visualization response based on intent analysis of a natural language query and a process of determining whether individual data cells of the format are capable of being filled based on an understanding of enterprise data.

Embodiments of the present disclosure provide a method and a system for enhancing inference and decision-making support functions of enterprise-specific sLLM services by providing a method for generating values required for data cells by calculating the enterprise data when the individual data cells of the format are incapable of being filled from the enterprise data.

Problems to be solved by the present disclosure are not limited to the above-described problem, and other problems not mentioned herein may be clearly understood from this specification and the accompanying drawings by those skilled in the art to which the present disclosure pertains.

According to an embodiment, a method for providing a response to a user query based on a large language model (LLM) in a server includes storing user data in a data storage module, analyzing intent of a natural language query when receiving the natural language query from the user, making a request for a format of a table and/or a chart according to the intent of the natural language query to the LLM when the intent of the natural language query includes a response in a form of the table and/or the chart, determining whether a response in a form of a table and/or a chart is possible, based on whether data required from the format is capable of being found from the user data or is capable of being computed from the user data, generating, by the LLM, a response to the natural language query in the form of the table and/or the chart based on the user data when the response is possible, and providing the user with the data as a data source together with the response. Here, the making of the request for the format of the table and/or the chart according to the intent of the natural language query to the LLM includes expanding the natural language query from the user based on paraphrasing by applying rule-based paraphrasing and LLM-based paraphrasing in a hybrid method, performing preprocessing by tokenizing the user query expanded based on the paraphrasing into individual words or morphemes and normalizing the individual words or the morphemes, performing analysis of a key word and a sentence structure on the preprocessing result to determine one of a table, a chart, and general text as a response format for the natural language query, and requesting the format of the table and/or the chart according to the determined response format.

According to an embodiment, a device providing a response to a user query based on a large language model (LLM) includes a data storage unit that stores user data, a communication unit that communicates with a user device, a control unit that analyzes intent of a natural language query when receiving the natural language query from a user, makes a request for a format of a table and/or a chart according to the intent of the natural language query to the LLM when the intent of the natural language query includes a response in a form of the table and/or the chart, and determines whether a response in a form of a table and/or a chart is possible, based on whether data required from the format is capable of being found from the user data or is capable of being computed from the user data, and the LLM that generates a response to the natural language query in the form of the table and/or the chart based on the user data. The control unit provides the user with the data as a data source together with the response. The control unit expands the natural language query from the user based on paraphrasing by applying rule-based paraphrasing and LLM-based paraphrasing in a hybrid method to the intent of the natural language query, perform preprocessing by tokenizing the user query expanded based on the paraphrasing into individual words or morphemes, and normalizing the individual words or the morphemes, performs analysis of a key word and a sentence structure on the preprocessing result to determine one of a table, a chart, and general text as a response format for the natural language query, and requests the format of the table and/or the chart according to the determined response format.

According to an embodiment, provided is a non-transitory computer-readable recording medium storing a computer program for performing the method for providing a response to a user query based on an LLM in combination with hardware.

Solutions to the problem of the present disclosure are not limited to the above-described solution, and solutions not mentioned herein may be clearly understood from this specification and the accompanying drawings by those skilled in the art to which the present disclosure pertains.

### BRIEF DESCRIPTION OF THE FIGURES

The above and other objects and features of the present disclosure will become apparent by describing in detail embodiments thereof with reference to the accompanying drawings.

FIG. 1 is a schematic diagram of an LLM-based data representation generation system, according to an embodiment of the present disclosure.

FIG. 2 is a flowchart illustrating a method for recognizing unstructured data based on an LLM and generating a data representation, according to an embodiment of the present disclosure.

FIG. 3 is a structural diagram of a table data recognition device, according to an embodiment of the present disclosure.

FIG. 4 is a flowchart illustrating a method for processing table data, according to one embodiment of the present disclosure.

FIG. 5 is a diagram illustrating an aspect of processing table data, according to one embodiment of the present disclosure.

FIGS. 6 and 7 are flowcharts illustrating a method for processing table data, according to one embodiment of the present disclosure.

FIG. 8 is a flowchart illustrating an operation of recognizing table data and generating a response based on the table data, according to an embodiment of the present disclosure.

FIG. 9 is a structural diagram of a chart data recognition device, according to an embodiment of the present disclosure.

FIGS. 10 and 11 are flowcharts illustrating a chart recognition method, according to an embodiment of the present disclosure.

FIG. 12 is a flowchart illustrating an operation of recognizing chart data and generating a response based on the chart data, according to an embodiment of the present disclosure.

FIG. 13 is a flowchart for describing a method for generating table data, according to an embodiment of the present disclosure.

FIG. 14 is a flowchart for describing a method for generating chart data, according to an embodiment of the present disclosure.

FIG. 15 is an example of a user interface that provides a response in a table form, according to an embodiment of the present disclosure.

### DETAILED DESCRIPTION

The above-described purposes, features, and advantages of the present disclosure will become more apparent through the following detailed description taken in conjunction with the accompanying drawings. However, the present disclosure is susceptible to various modifications and embodiments. Hereinafter, specific embodiments are shown by way of examples in the drawings and will herein be described in detail.

Throughout the specification, identical reference numbers refer to generally identical components. Moreover, components with the same function within the scope of the same concept shown in the drawings of each embodiment are described by using the same reference numerals, and redundant descriptions thereof will be omitted.

When a detailed description of a known function or configuration related to the present disclosure is deemed to unnecessarily obscure the gist of the present disclosure, the detailed description will be omitted. Numeral figures (e.g., 1, 2, etc.) used during describing the specification are just identification symbols for distinguishing one element from another element.

Furthermore, suffixes “module” and “part” for a component used in the following embodiments are assigned or used interchangeably solely for the convenience of writing the specification, and do not inherently have distinct meanings or functions.

In the following embodiments, singular forms include plural forms unless interpreted otherwise in context.

In the following embodiments, terms such as “include” or “have” indicate the presence of features or components described in the specification, and do not preclude the possibility of one or more other features or components being added.

In the drawings, for convenience of description, sizes of components may be exaggerated or reduced. For example, the sizes and thicknesses of each component shown in the drawings are arbitrarily shown for convenience of description, and the present disclosure is not necessarily limited to the illustrated examples.

When an embodiment is capable of being implemented differently, the order of specific processes may be performed differently from the order described. For example, two processes described in succession may be performed substantially simultaneously or in an order reversed from the order described.

In the following embodiments, a case where components are connected includes not only a case where components are directly connected, but also a case where components are interposed between components and thus indirectly connected.

For example, in this specification, a case where a component is electrically connected includes not only a case where a component is directly electrically connected, but also a case where a component is interposed in between and is connected indirectly and electrically.

According to an embodiment of the present disclosure, a method for providing a response to a user query based on a large language model (LLM) in a server may include storing user data in a data storage module, analyzing intent of a natural language query when receiving the natural language query from the user, extracting data related to the query from the data storage module, determining whether a response in a form of a table and/or a chart is possible, based on the data when the intent of the natural language query includes a response in a form of the table and/or the chart, generating, by the LLM, a response to the natural language query in the form of the table and/or the chart based on the data, and providing the user with the data as a data source together with the response.

According to an embodiment of the present disclosure, the method for providing the response to a user query based on the LLM in the server may include make a request for the format of the table and/or the chart according to the intent of the natural language query to the LLM.

According to an embodiment of the present disclosure, the method for providing the response to a user query based on the LLM in the server may include determining the possibility of a response in the form of the table and/or the chart based on whether data required in the format is found from the user data stored in the data storage module, or is computed from the user data.

According to an embodiment of the present disclosure, the method for providing the response to a user query based on the LLM in the server may include requesting the LLM to generate a response together with data related to the query and the format of the table and/or the chart.

According to an embodiment of the present disclosure, the method for providing the response to a user query based on the LLM in the server may include assigning a response region, a data source region, and a modification request region for the response to a display of the user.

According to an embodiment of the present disclosure, the method for providing the response to a user query based on the LLM in the server may include reflecting a change request for at least one of a field, a scale, and a format of the table and/or the chart received from the user.

According to an embodiment of the present disclosure, a device providing a response to a user query may include a data storage unit that stores user data, a communication unit that communicates with a user, a control unit that analyzes intent of a natural language query when receiving the natural language query from a user, extracts data related to the query from the data storage unit, and determines whether a response in a form of a table and/or a chart is possible, based on the data when the intent of the natural language query includes a response in a form of the table and/or the chart, and an LLM that generates a response to the natural language query in the form of the table and/or the chart based on the data. The control unit may provide the user with the data as a data source together with the response.

According to an embodiment of the present disclosure, a medium may store a computer program to perform storing user data in a data storage module, analyzing intent of a natural language query when receiving the natural language query from the user, extracting data related to the query from the data storage module, determining whether a response in a form of a table and/or a chart is possible, based on the data when the intent of the natural language query includes a response in a form of the table and/or the chart, generating, by the LLM, a response to the natural language query in the form of the table and/or the chart based on the data, and providing the user with the data as a data source together with the response.

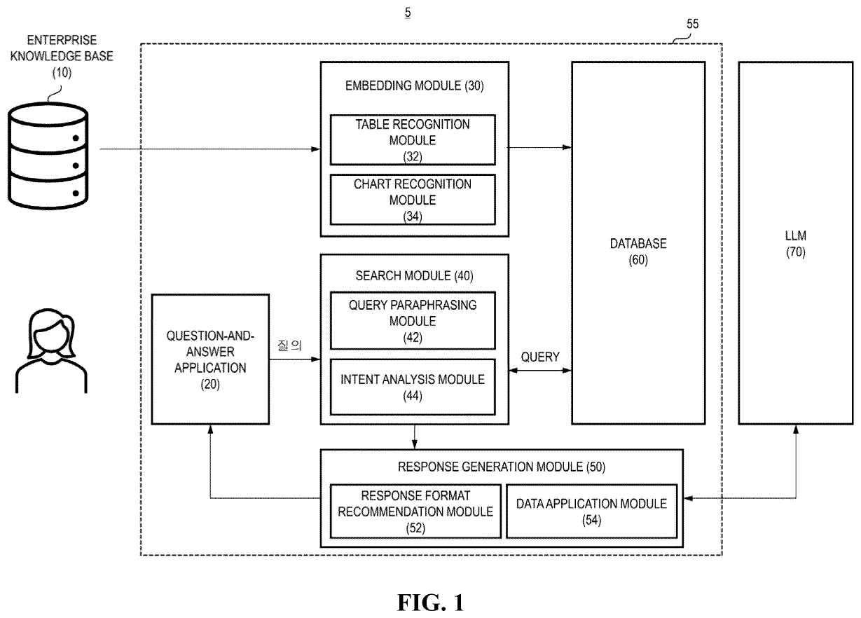

Hereinafter, a method and a system for generating LLM-based data representations according to an embodiment of the present disclosure will be described with reference to FIGS. 1 to 16.

FIG. 1 is a schematic diagram of an LLM-based data representation generation system, according to an embodiment of the present disclosure. A data representation generation system according to an embodiment of the present disclosure may perform a function that supports data-based decision-making in enterprises and enhances work efficiency.

A data representation generation system 5 according to an embodiment of the present disclosure may include an enterprise knowledge base 10, a question-and-answer application 20 of an enterprise user, an embedding module 30, a search module 40, a database 60, a response generation module 50, and/or an LLM 70. In the case, the LLM 70 may not be included in the data representation generation system 5, but may be connected via an Application Programming Interface (API), or may be embedded into the data representation generation system 5. When the LLM 70 is externally connected via the API, the data representation generation system according to an embodiment of the present disclosure is as shown in 55 of FIG. 1.

The LLM 70 according to an embodiment of the present disclosure may be a lightweight model installed on computing assets of a company, or a large model connected to a system of the company via the API. The lightweight model may be directly installed and operated in the company's internal server, and knowledge distillation or quantization techniques may be applied thereto to reduce a model size.

The LLM 70 according to an embodiment of the present disclosure may learn domain knowledge related to the company's business. For example, the LLM 70 may be generated in a method of fine-tuning a pre-trained model by using enterprise documents and enterprise terminology. Furthermore, the LLM 70 may filter out pre-categorized sensitive information for enterprise services or may control data access according to permissions by identifying user permissions. Besides, the LLM 70 may provide a data source that is the basis of the response. In particular, the LLM 70 according to an embodiment of the present disclosure may understand and interpret tables and charts, and may make mathematical inferences from data regarding the tables and the charts.

In the meantime, enterprise data may include structured data such as RDBMS (Relational Database Management System), graphDB (Graph Database), and JSON (JavaScript Object Notation), and unstructured data such as documents in PDF, PPT, XLS, and HWP formats, images, or web pages, and may be stored in the enterprise knowledge base 10.

The LLM-based data representation generation system according to an embodiment of the present disclosure may include the embedding module 30. The embedding module 30 may convert the enterprise data into fixed-dimensional vectors and may perform a function of representing the semantic similarity of data in a vector space.

The embedding module may represent a set of encoder models for each modality. The encoder models include a text encoder such as BERT (Bidirectional Encoder Representations from Transformers), an image encoder such as ResNet (Residual Network), an audio encoder such as WaveNet, and a video encoder such as I3D (Inflated 3D ConvNet).

The embedding module 30 may obtain structured enterprise data and unstructured enterprise data, such as text, images, audio, video, tables, and graphs, from an enterprise knowledge base and may convert the data into vector representations. Furthermore, the embedding module may extract semantic alignment vector representations for multi-modality data in a common embedding space.

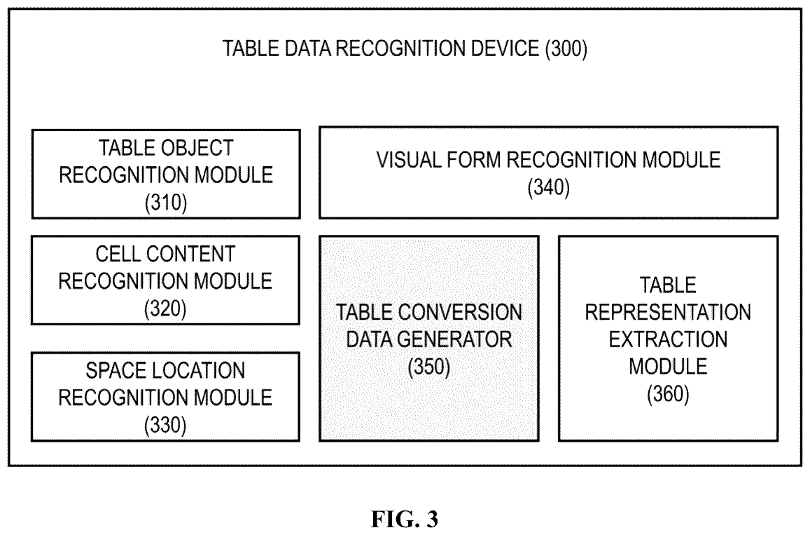

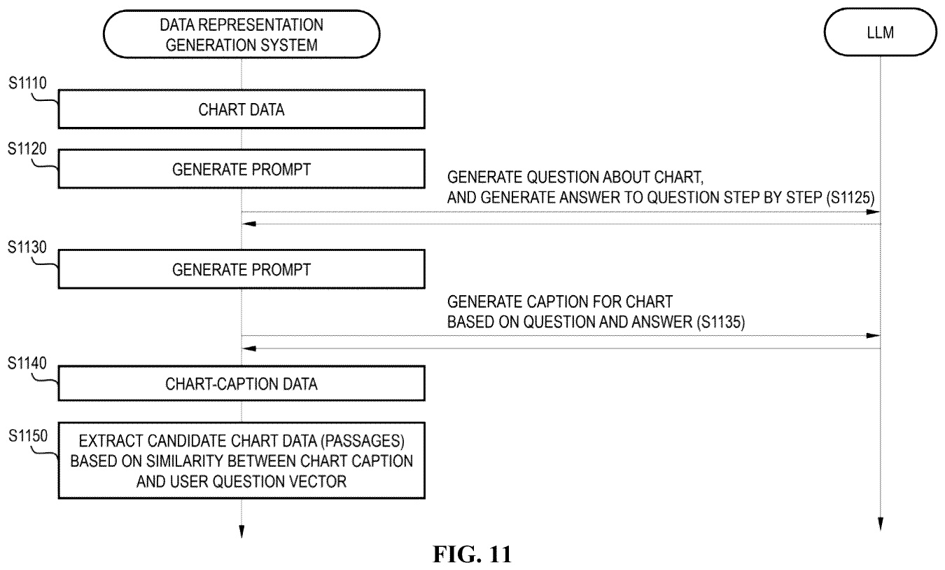

In the meantime, the embedding module 30 of the LLM-based data representation generation system according to the embodiment of the present disclosure may include a table recognition module 32 that performs embedding on data in a table format, and a chart recognition module 34 that performs embedding on data in a chart format. A detailed description of the table recognition module 32 and the chart recognition module 34 will be given later in the description of FIGS. 3 and 11.

Although not illustrated in FIG. 1, the embedding module according to an embodiment of the present disclosure includes a preprocessing module, which may perform functions of refining original data, normalizing text, removing noise, and unifying a data format. In particular, the preprocessing module according to an embodiment of the present disclosure may perform domain-specific processing. To this end, it may perform a function that applies a pre-built target domain terminology dictionary to process terms in enterprise data, normalizes abbreviations, or reflects business logic.

The LLM-based data representation generation system according to an embodiment of the present disclosure may structure the enterprise data into a vector database and may store the structured result in the database 60. In the case, an index may be formed to effectively search for a high-dimensional vector data set. Indexing may be performed in various ways, and the present disclosure should not be construed as being limited thereto. Here, the LLM-based data representation generation system according to an embodiment of the present disclosure may represent enterprise data as a graph including a node indicating the characteristic value of a data point, and an edge indicating the relationship between a plurality of nodes. The graph may be formed in a hierarchical structure. For example, the vector of the data point in the graph may be represented as a graph node, and an adjacent vector may be connected to an edge. Furthermore, the hierarchical structure may be formed by forming a plurality of layers, forming all nodes in the lowest layer, and forming fewer nodes as it goes to an upper layer.

Furthermore, the database 60 of the LLM-based data representation generation system according to an embodiment of the present disclosure may store data obtained by modeling business domain knowledge to reflect the business domain characteristics of a company in its services. In more detail, the query response system may analyze a business domain to which the enterprise data belongs, and may collect the company's requirements to create a domain knowledge model through a process of designing ontology, integrating a data source, and defining and matching a relationship. This may be utilized for context-based reasoning and semantic search with respect to the enterprise data.

The LLM-based data representation generation system according to an embodiment of the present disclosure may include the question-and-answer application 20 installed on a user device to receive queries from enterprise users. When a user's query in natural language is received by a service server through the question-and-answer application 20, the service server may apply the user's query to a vector embedding model to express the query as a query vector. In this way, the enterprise data similar to the query may be found in the database 60.

The LLM-based data representation generation system according to an embodiment of the present disclosure may include the search module 40. The search module may perform a function of paraphrasing the user's query in various forms and analyzing the user's intent.

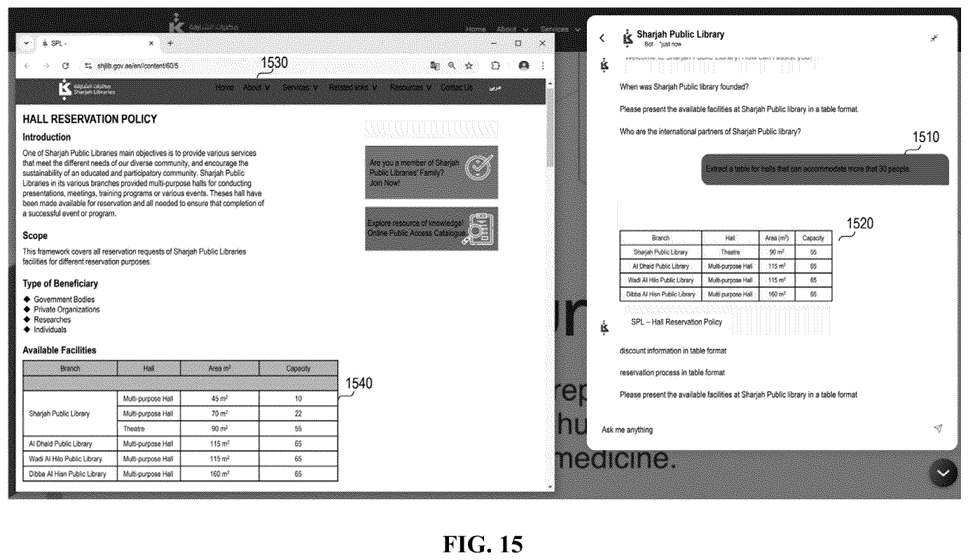

For example, a user interface such as that shown in FIG. 15 may be considered.

When a user query is entered in natural language, as shown in 1510, the user query 1510 will be embedded in a query vector. Afterwards, a document 1530 related to the user query (“Find a table for a hall capable of accommodating 30 people or more”) may be found in a database 60, and a table 1540 included in the document 1530 may be extracted. Afterwards, the table 1540 may be extracted as only data for the hall capable of accommodating 30 people or more, and a response in the form of a table, such as 1520, may be provided.

In particular, the search module 40 according to an embodiment of the present disclosure may include a query paraphrasing module 42. The query paraphrasing module 42 may reconstruct the user query received through the question-and-answer application 20 into various forms to improve the performance of the search module 40. According to an embodiment of the present disclosure, the query paraphrasing module 42 may deliver, to the LLM 70, a prompt instructing expanding the query in a method of i) maintaining the meaning of the original query, ii) maintaining the context of a the conversation history, and iii) improving search coverage along with the original query, and then may receive a response from the LLM 70 to expand the query. In the case, according to an embodiment of the present disclosure, to manage computational costs, the query paraphrasing module may construct a query paraphrase database in the database 60 rather than instructing the LLM 70 to paraphrase all queries, and may provide a query paraphrasing algorithm to apply rule-based paraphrasing and LLM-based paraphrasing as a hybrid method.

Furthermore, the search module 40 according to an embodiment of the present disclosure may include an intent analysis module 44. The intent analysis module 44 may identify the intent of a user query, may classify the type and purpose of the query, and may reflect the classified result to a response.

To this end, the intent analysis module 44 may perform preprocessing, such as tokenizing the paraphrased user query, separating the tokenized result into individual words or morphemes, and normalizing the individual words or the morphemes. Furthermore, the intent analysis module 44 may identify the core intent by analyzing the main keywords and sentence structure of the preprocessed user query. In addition, the intent analysis module 44 may classify and materialize the intent by reflecting context, such as previous conversation history and situational information.

In particular, the intent analysis module 44 according to an embodiment of the present disclosure may identify the intent for data representations, such as graphs and/or charts, in the user query. For example, when the user query is entered as “What are recent sales of our product? Who are our top three customers?”, the intent analysis module 44 may extract the intent for requesting a response in the form of a data table of recent sales amount and a visual chart of sales amount by customer. In this case, when the intent of the data representation, such as a graph and/or a chart, is ambiguous in the user query, this may be clarified through the user query.

Furthermore, although not illustrated in FIG. 1, the search module of the LLM-based data representation generation system according to an embodiment of the present disclosure may include a passage search module. The passage search module may retrieve documents relevant to the user query from the database 60 and may extract a region, which is highly relevant to the user query, as a passage. Moreover, the passage search module may predict the probability that the extracted passage includes the correct answer to the query.

Furthermore, the passage search module may extract the correct answer when the probability that the passage includes the correct answer is greater than or equal to a threshold value, i.e., when the passage includes the correct answer to the query. For example, the passage search module may understand a user query composed in natural language and may derive an answer corresponding to the user query from the passage.

The LLM-based data representation generation system according to an embodiment of the present disclosure may include the response generation module 50. The response generation module 50 generates a response to the user query based on the enterprise data, and may perform a function of verifying the reliability of the response, tracing a source, and monitoring the response.

A case where the correct answer to the user query is included in an enterprise document in the form of a table or a chart may be considered. In more detail, according to an embodiment of the present disclosure, a case may be considered where a passage obtained by extracting the user query from the search module 40 is a table or a chart, and the passage includes the correct answer to the query. In this case, the response generation module 50 according to an embodiment of the present disclosure may deliver the user query, the passage in the form of a table or chart, and the correct answer extracted from the passage to the LLM 70, while instructing the LLM to generate a sentence for a response. For example, when a user queries, “What are the top three customers for a specific product?” and the enterprise document includes table data on sales amount by customer for the corresponding product, the search module 40 may extract the table data as a passage and may extract names A, B, and C of the top three customers of sales amount as correct answers. The response generation module 50 may then deliver the user query, the table data, and the correct answers A, B, and C to the LLM 70 and may instruct the LLM 70 to generate a response sentence. Afterwards, the LLM 70 may generate a response sentence of “The top three sales sources for the corresponding product are A, B, and C.” with reference to the query, the table data, and the correct answers A, B, and C. Afterwards, the response generation module 50 may mark the passage as a data source and may provide the marked passage to the question-answering application 20 together with the response sentence generated by the LLM 70.

For another example, a case may be considered where the correct answers to the user query are distributed and written to a plurality of enterprise documents in the form of tables or charts. In this case, the response generation module 50 according to an embodiment of the present disclosure may deliver the user query, a plurality of passages in the form of a table or chart, and the correct answer extracted from the plurality of passages to the LLM, while instructing the LLM to generate a sentence for a response. For example, when the user queries, “What are the sales proportions of the top three customers for a specific product?” and the first enterprise document includes a chart regarding sales trends by customer for the corresponding product, and the second enterprise document includes a table including data regarding the sales amount ‘a’ for customer A, the sales amount ‘b’ for customer B, and the sales amount ‘c’ for customer C, the search module 40 may extract the first and second enterprise documents as passages, may extract the names of the top three customers A, B, and C of the sales amount as correct answers from the chart, and may extract a, b, and c as correct answers from the table. Afterwards, the response generation module 50 may deliver the user query, the first enterprise document, the second enterprise document, and the correct answers “A, B, C” and “a, b, c” to the LLM, and may instruct the LLM 70 to generate a response sentence. Afterwards, by using the query, table data, and correct answer data, the LLM 70 may generate a response sentence, for example, “The top three sales sources for the corresponding product are A, B, and C; the sales of A are ‘a’, the sales of B are ‘b’, and the sales of C are ‘c’; furthermore, the total sales for the product are ‘d’; the total sales of the top three sales sources A, B, and C are “a+b+c”, and this accounts for “a+b+c/d %” of the total.”. Afterwards, the response generation module 50 may mark the passage as a data source and may provide the marked passage to the question-answering application (20) together with the response sentence generated by the LLM 70.

In the meantime, the response generation module 50 according to an embodiment of the present disclosure may include a response format recommendation module 52. The response format recommendation module 52 may perform a function of extracting a format of a response data representation from the user query. In more detail, when the user query is categorized as the intent for a data representation, such as a graph or chart, through analysis of the main keywords and sentence structure of the preprocessed user query, the response format recommendation module 52 may extract the format of the response data representation by distinguishing between a necessary parameter (i.e., information absolutely necessary to complete the data representation) and an optional parameter for performing basic functions without the necessary parameter.

In the previous example, when the user query of “What are the recent sales of our product? Who are our top three customers?” is entered, the response format recommendation module 52 may extract “<year, product name, sales amount> as columns in the response data table and may extract <customer, sales amount> as fields in the visualization chart. Afterwards, the response format recommendation module 52 may recommend <Data table on sales amount by product over the past 5 years> and <Visualization chart on sales amount by customer over the past 5 years> as formats for response data representations.

Furthermore, the response generation module 50 according to an embodiment of the present disclosure may further include a data application module 54 that applies data to cells of a recommendation format based on the enterprise data.

The data application module 54 may determine whether a data cell of a response format is capable of being filled, based on the enterprise data. In more detail, the data application module 54 according to an embodiment of the present disclosure may create a query for fill the data cell in the response format with reference to the recommended response format, may deliver the query to the search module 40, and may receive a passage or correct answer to the query.

In the case where the data application module 54 determines that data for filling the recommended response format is incapable of being obtained from the enterprise data stored in the database 60, the response generation module 50 may provide information about the case to the question-and-answer application 20 and may inquire about changing the response format or request data for filling the response format.

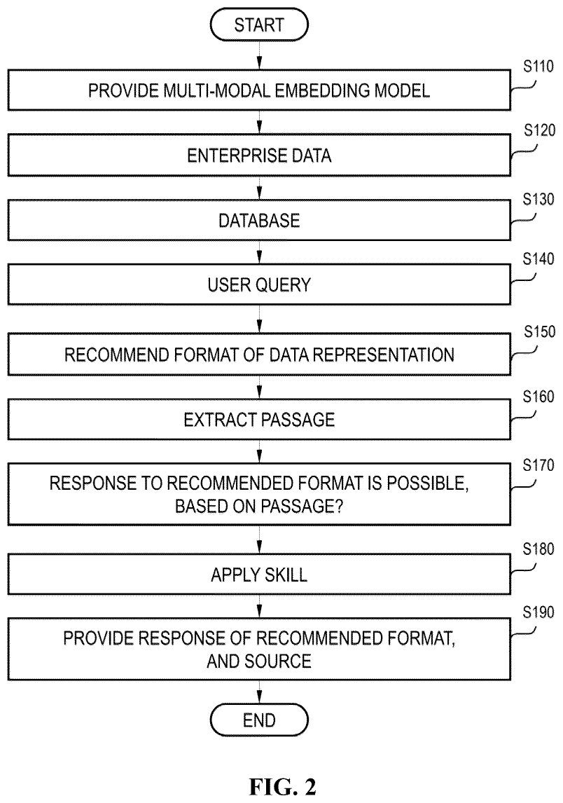

FIG. 2 is a flowchart illustrating a method for recognizing unstructured data and generating a data representation in an LLM-based data representation generation system, according to an embodiment of the present disclosure.

In operation S110, the data representation generation system according to an embodiment of the present disclosure may provide an embedding model. The embedding model may convert enterprise data into a fixed-dimensional vector and may represent the semantic similarity of data in a vector space. Furthermore, the embedding model may include an encoder model for each modality and/or a model that supports the alignment of encoding vectors and encoders of various modalities. The encoder models include a text encoder such as BERT, an image encoder such as ResNet, an audio encoder such as WaveNet, and a video encoder such as I3D. Based on this, the data representation generation system may map a vector value, which is extracted by each embedding model, to a common embedding space through Linear Projection to identically match the dimensions of each modality embedding, and may learn the interaction between two modalities by using Cross-Attention. In the case, through contrastive learning, related pairs of individual modality vectors may be learned to be closer, and unrelated pairs may be learned to be further apart, thereby establishing a multi-modal embedding model.

Subsequently, in operation S120, structured and unstructured enterprise data, such as text, images, audio, video, tables, and graphs, may be obtained from an enterprise knowledge base 10, and the embedding model is applied to convert the enterprise data into vector representations. The enterprise data may include structured data such as RDBMS, graphDB, and JSON, and unstructured data such as documents in PDF, PPT, XLS, and HWP formats, images, or web pages.

In operation S130, a data representation generation system according to an embodiment of the present disclosure may structure the enterprise data into a vector database to build a database for data of a target enterprise. In this case, an index may be formed to effectively search for the enterprise data being a high-dimensional vector. In the case, the data representation generation system according to an embodiment of the present disclosure may represent enterprise data as a graph including a node indicating the characteristic value of a data point, and an edge indicating the relationship between a plurality of nodes, and the graph may be formed in a hierarchical structure. For example, the vector of the data point in the graph may be represented as a graph node, and an adjacent vector may be connected to an edge. Furthermore, the hierarchical structure may be formed by forming a plurality of layers, forming all nodes in the lowest layer, and forming fewer nodes as it goes to an upper layer.

In operation S140, the data representation generation system according to an embodiment of the present disclosure may receive a query from an enterprise user. The user query may be received in natural language through a question-and-answer application 20 installed on a user device. The natural language query may be applied to an embedding model and may be expressed as a query vector.

In the case, according to an embodiment of the present disclosure, the query may be paraphrased into a form suitable for the task of the data representation generation system. In more detail, the query may be paraphrased in a method of i) maintaining the meaning of an original query, ii) maintaining the context of a conversation history, and iii) enhancing search coverage.

In operation S150, the data representation generation system according to an embodiment of the present disclosure may extract intent from the user query. When the intent of the user query includes a response in the form of a data representation, such as a graph and/or a chart, the data representation generation system may recommend the format of the response data representation that reflects the intent.

In more detail, the data representation generation system may identify the response intent for data representations, such as graphs and/or charts, in the user query. For example, when the user query “Please tell me details on the safety incidents that occurred over the past six months, and how the types of incidents have changed compared to the year before last” is entered, the data representation system may extract, from the user query, the intent requiring a response in a format of a table or a chart that provides the number of safety accidents last year and the number of safety accidents over the past five months by accident type.

Furthermore, the format of the response data representation may be extracted from the user query and the intent extracted from the user query. In the previous example, <accident type, number of accidents and proportion by accident type in the year before last, and number of accidents and proportion by accident type in the past six months> may be extracted as the columns in the response data table and/or the fields in the visualization chart. Based on this, the data representation generation system may recommend the format of a response data representation for <changes in types of safety accidents that occurred in 2022 (the year before last) and the first half of this year>.

In operation S160 and operation S170, the data representation generation system according to an embodiment of the present disclosure may determine whether a data cell in a response format is capable of being filled, based on enterprise data. In more detail, a query may be created to fill the data cell in the response format with reference to the recommended response format. Afterwards, the data representation generation system may search for a document relevant to the query in an enterprise database, and may extract a region highly relevant to the query as a passage from the document (S160). Furthermore, when the probability that the passage includes the correct answer is greater than or equal to a threshold value, i.e., when the passage includes the correct answer to the query, the correct answer may be extracted. The data representation generation system according to an embodiment of the present disclosure may determine whether data for filling a recommended response format is capable of being obtained with reference to the correct answer and passage (S170). When it is determined that it is impossible to obtain data, the data representation generation system may display this information on a user device and may inquire about changing the response format or request data for filling the response format.

In the meantime, in a query response system, a case may be considered where a passage determined to be highly relevant to a query is found, but it is difficult to extract a direct correct answer to the query from the passage. In this case, the system according to an embodiment of the present disclosure may apply a preset skill to generate the correct answer from the passage (operation S180). The skill may include filtering, conversion, calculation, approximation, and the like. An operation for applying the skill may be performed by the LLM 70 included in the system according to an embodiment of the present disclosure or may be performed by applying a separate model or an algorithm.

For example, with respect to a question of “among all national parks in our country, list those with an elevation of 1,500 meters or higher by height,” when a passage includes a list of national parks and their respective elevation information, the system may filter the national parks based on 1,500 m and extract the correct answer (Filtering). For another example, when numerical data or unit conversion is required, the system may perform unit conversion calculations to derive the correct answer (Conversion). For still another example, with respect to a question of “What was the total sales of snacks A and beverage B at Mart A last year?”, the system may extract price information and sales volume information for each product from a passage to calculate sales (Calculation). For yet another example, when the passage includes information such as “1,752 full-time employees in 2022” with respect to a question of “approximately how many employees will there be in 2022?”, an approximate value may be provided as “approximately 1,700” (Approximation).

In operation S190, the data representation generation system according to an embodiment of the present disclosure may provide a user with a response in the form of a table and/or a chart based on the enterprise data. The response may be provided through a question-and-answer application installed on the user device, and may be provided along with a data source formed the basis for generating the response.

FIG. 3 is a structural diagram of a table data recognition device, according to an embodiment of the present disclosure. A table data recognition device according to an embodiment of the present disclosure effectively extracts meaningful information from table data and provides a function for processing and interpreting the information in conjunction with an LLM 70.

A table data recognition device 300 of FIG. 3 is a device performing the function of the table recognition module 32 of FIG. 1 and performs the function of recognizing various types of table data acquired from the enterprise knowledge base 10 and converting them into vectors.

A table object recognition module 310 of FIG. 3 may recognize table data in an enterprise document. The table object recognition module 310 may identify and recognize each object constituting a table, such as a table region, a cell, and a header, from the recognized table data. The table object recognition module 310 may recognize structural elements of a table by using a convolutional neural network (CNN)-based object detection model. In the case, each component of the table is processed as an individual object with different characteristics; the table region may be identified as the entire bounding box; each cell may be identified as an internal segmented region; and the header may be identified as the top-level cell with a special meaning.

A cell content recognition module 320 of FIG. 3 may extract text information within a cell by performing optical character recognition (OCR) on each cell region identified by the table object recognition module 310. The cell content recognition module 320 may apply optimized OCR parameters by using the size and location information of a cell, and may recognize various types of text, including numbers, letters, and special characters. Moreover, even in a complex table structure such as cell merging or splitting, the content of each cell may be independently processed to extract text for each cell.

A space location recognition module 330 of FIG. 3 may match the text content and spatial location information of each cell by using the results of the table object recognition module 310 and the cell content recognition module 320. In the case, the space location recognition module 330 may calculate the relative location of each cell based on row and column information of the table and may convert the relative location into a cell address system (e.g., A1, B2, etc.) in Excel or spreadsheet format. Besides, when cell merging occurs, the space location recognition module 330 may identify the start and end points of the corresponding region to generate range information (e.g., A1:B2) of the merged cell. This allows the content of each cell to be stored together with accurate location information while the structural characteristics of the table are maintained.

A visual form recognition module 340 of FIG. 3 may reflect the semantic characteristics of visual elements, such as lines, borders, colors, fonts, and shading of a table to encoding. In the case, the visual form recognition module 340 may analyze the visual characteristics of each object detected by the table object recognition module 310 and may extract data grouping information represented by a border thickness and a style, emphasis or distinction information of data through color or shading, and importance information of data represented by a font size or a style. Moreover, the extracted visual characteristics may be converted into numerical vectors through a pre-learned embedding model, which may be utilized as important feature information expressing the hierarchical order and the structural relationship of the table data. A table conversion data generator 350 of FIG. 3 may generate conversion data from the table data. In particular, the conversion data may be generated in a form for enhancing the accuracy of table recognition of an LLM.

Unlike data in character or image format, the table data has the characteristic that the table structure itself expresses the hierarchy and the relationship between pieces of data. In particular, for example, companies possess numerous tables with complex structures that are difficult to parse, and the tables have a case where there is a merged cell with multiple field values in a single cell, a case where the number of columns is different for each row, a case where there is a missing or incomplete header, a case where there are multiple header rows, a case where cells are merged horizontally or vertically, a case where there is an overlapping table, a case where a format of date, number, or currency is inconsistent, a case where there is a need to distinguish between an empty cell and simply missing data, a case where a comment is included in a table or around the table, a case where important metadata is present outside the table, or the like. The table conversion data generator 350 of FIG. 3 has a configuration for generating conversion data for enhancing LLM 70 recognition from complex table data, which is difficult to encode.

The table conversion data generator 350 according to an embodiment of the present disclosure may generate conversion data by converting two-dimensional table data into a one-dimensional format. In this case, the table conversion data generator may perform conversion by sequentially listing location information, content, and visual characteristics of each cell while maintaining the structural relationship of the table, and explicitly expressing the relationship between cells. Furthermore, the table conversion data generator 350 according to another embodiment of the present disclosure may generate a proxy table for increasing the correct answer rate of LLM response generation from the original table data. In the case, the proxy table may serve as a passage for a user query. This may be utilized in the case of generating a response to the user query in an LLM 70 based on the table data.

To this end, according to the first embodiment of the present disclosure, the table conversion data generator may provide an operation pool and may generate a proxy table by using the operation pool. In this case, the complex structure of original table data is analyzed to generate a normalized proxy table. The proxy table may be generated to resolve the user query, i.e., to derive the response to the query.

According to the second embodiment of the present disclosure, the table conversion data generator may generate the proxy table for deriving the response to the user query in collaboration with the LLM. More specifically, the table conversion data generator may generate the proxy table through a prompt that allows the LLM to identify cells difficult to parse, to generate a question for identifying the meaning of the cell, and then to repeatedly perform an operation of obtaining a response to the question.

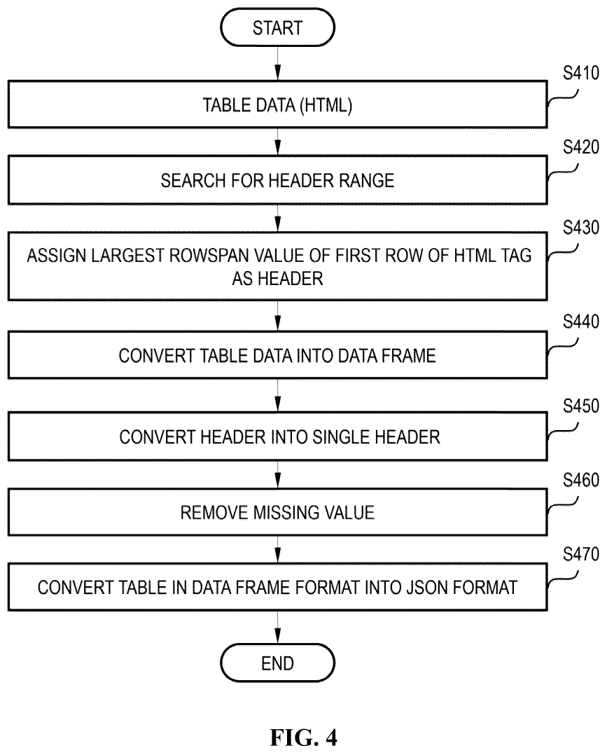

An operation of the table conversion data generator 350 according to the embodiment of the present disclosure is described in detail in the attached description of FIGS. 4 to 7.

A table representation extraction module 360 of FIG. 3 performs a function of outputting recognized table data in various data formats, such as HTML, JSON, Markdown, and XML. This enables the table data to be used in various applications or systems, thereby increasing the usability of table data.

Although not separately illustrated in FIG. 3, the table data recognition device 300 according to the embodiment of the present disclosure may further include a table information integration module. The table information integration module may generate a vector representing the overall meaning of the table by integrating information extracted and converted from each of the modules 310 to 350 described above. In this case, the table information integration module may perform embedding that combines structural information of a table object, text information of cell content, spatial location relationship information, and visual form information. Moreover, the generated integrated vector is converted into a form understandable by the LLM 70 to be utilized for various natural language processing tasks, such as question-answering, summarization, and analysis of table data.

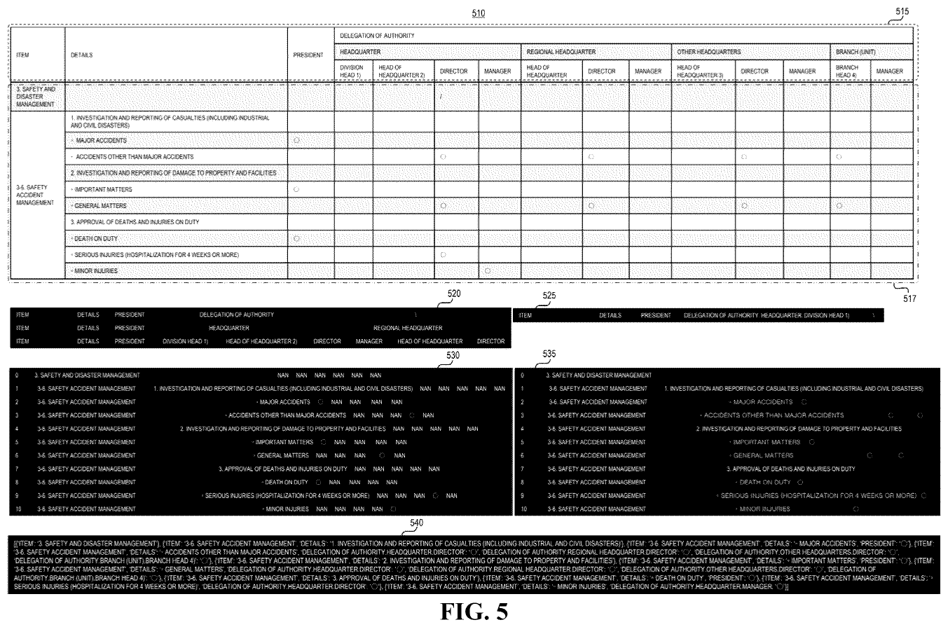

FIG. 4 is a flowchart illustrating a process for generating conversion data from table data, according to an embodiment of the present disclosure. FIG. 5 is a diagram illustrating one aspect of processing table data according to the method of FIG. 4.

The reason for generating conversion data in a data representation generation system according to an embodiment of the present disclosure is to enhance the understanding of table data of an LLM 70. Unlike data in character or image format, the table data has the characteristic that the table structure itself expresses the hierarchy and the relationship between pieces of data. However, a case where the table structure is unstructured (e.g., a case where there is no header or a header is incomplete, a case where there are multiple header rows, or a case where cells are merged horizontally or vertically) may be considered. Humans may understand the relationships between data cells within the overall context of a complex table structure. However, the LLM 70 learned primarily by using natural language text may struggle to understand a table structure.

For example, a case may be considered where table data regarding “delegated decisions by authority” is present in an enterprise document, a question of “To whom may the authority to delegate decisions regarding the operation of the subcontract review committee be delegated?” is received, and an accurate answer to this question needs to be based on the table data. For the LLM 70 to perform this task, a cell corresponding to the correct answer, and field information of a row and a column including information about the cell need to be found from the table data for “delegated decisions by authority”. As the cell is further from the response, the search accuracy becomes lower, and it becomes difficult to utilize attention mechanisms within the context of a typical sentence form.

Accordingly, according to embodiments of the present disclosure, a special encoding method for processing structured data may be introduced to enhance the understanding of the table data of the LLM 70. In more detail, according to embodiments of the present disclosure, 2D information, such as table data, may be delivered as a one-dimensional (1D) vector in key-value format such as JSON, which the LLM 70 is capable of being understood through pre-training on a basic corpus.

In the example of FIG. 4, in operation S410, a table data recognition device 300 according to an embodiment of the present disclosure may obtain the table data in HTML format.

When the table data is in an image format not HTML, a process of converting a table in an image format into a HTML format may be performed as follows, although not shown separately in FIG. 4.

In more detail, the table data recognition device may first perform a preprocessing task for analyzing a table image. The structure of the table may be made clearer through improving image quality, removing noise, and black-and-white conversion and contrast adjustment. Moreover, when the table is tilted in the image, a task of correcting the tilted table may be performed.

Next, the table structure may be identified from the image. A grid structure of the table may be identified by detecting horizontal and vertical lines. In this way, the location and size of an individual cell may be determined. In the case, cells requiring rowspan, which an attribute specifying the number of rows in which a table cell (td or th) vertically occupies in an HTML table, or colspan, which is an attribute used to merge cells horizontally in the HTML table may be identified by analyzing the connection relationship of a line in consideration of a case where there is cell merging.

Next, Optical Character Recognition (OCR) may be applied to extract the text within each cell. In the extracted text, recognition errors may be corrected through a post-processing process, and unnecessary spaces and special characters may be removed. In the case, style information, such as a font size, boldness, and an alignment method, may also be analyzed to distinguish between header cells and regular cells.

Finally, the table data recognition device 300 may generate a HTML code based on the analyzed table structure and text content. The table structure may be expressed by using tags such as <table>, <tr>, <td>, and <th>, and rowspan and colspan attributes may be set when cell merging is required. Besides, a Cascading Style Sheets (CSS) attribute, which is a style rule for defining the visual design and layout of a web page, may be added to maintain the style of the original table as much as possible.

For example, when a table data recognition device 300 according to an embodiment of the present disclosure converts a table, such as reference numeral 510 in FIG. 5, into a HTML format, a table structure may be implemented by using table, thead, tbody, tr, th, and td tags. Items and details may be merged by using the rowspan attribute to simplify the structure. Furthermore, ranks within each department (a headquarter, a regional headquarter, other headquarters, and branch offices) may be segmented into columns by using the colspan attribute, and cells marked with Û may be implemented as it is.

Returning to the description of FIG. 4, in operation S420, the table data recognition device 300 may search for a header range in the table data.

In more detail, the table data recognition device 300 may extract all of a td (a regular cell) tag or a th (a header cell) tag from the first row of the HTML table and may identify a rowspan attribute value of each cell. In operation S430, the table data recognition device 300 may found the largest rowspan value among the identified rowspan attribute values and assigned as a header region. For example, when the largest rowspan value among the cells in the first row is 3, the top three rows may be considered as a header.

Reference numeral 515 of FIG. 5 illustrates a header range in the table data. To extract the header 515, the table data recognition device 300 may extract cells with the rowspan attribute from the first row of the HTML tag of table 510 and may identify the rowspan attribute value as follows:

“Item” cell: rowspan=“3” “Details” cell: rowspan=“3” “President” cell: rowspan=“3” . . . .

In the case, among cells with rowspan attribute values in the first row, the largest rowspan value is 3, and cells with rowspan=“3” may be assigned as a header region.

Returning to the description of FIG. 4, in operation S440, the table data recognition device 300 may convert table data in a HTML format into a data frame. This is for preprocessing.

Next, in operation S450, the table data recognition device 300 may convert a header in the table in the data frame format into a single header. In more detail, the single header may be generated by removing redundancy from the header in a data frame format and merging pieces of content of the split cells. The single header is a region corresponding to KEY when the table data is converted to JSON.

Next, in operation S460, the table data recognition device 300 may remove a missing value from the table in the data frame. This is to reduce LLM tokens.

In the example of FIG. 5, table data 510 may be formatted from a HTML to a data frame. In this case, header 515 may become reference numeral 520. Reference numeral 520 may be converted to a single header, as shown in reference numeral 525, by removing redundancy and merging the pieces of content of the split cells.

A body 517 of the table data 510 in FIG. 5 may also be formatted from the HTML to the data frame and may be expressed as reference numeral 530. According to an embodiment of the present disclosure, a missing value may be removed and thus reference numeral 530 may be expressed as reference numeral 535.

Returning to the description of FIG. 4, in operation 470, the table data recognition device 300 may convert a preprocessed table in the data frame format into a JSON format. This is to centrally store information required for LLM 70 to generate a response based on a table in a key of JSON-formatted data.

For example, in the example of FIG. 5, after preprocessing, the table data 510 may be converted to a JSON format such as reference numeral 540.

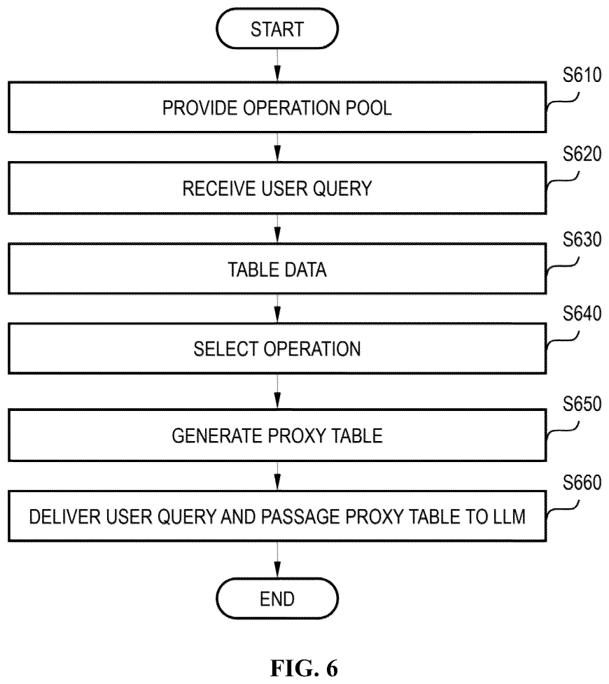

FIG. 6 is a flowchart illustrating a method for extracting conversion data from table data, according to an embodiment of the present disclosure.

A data representation generation system according to another embodiment of the present disclosure may generate a proxy table for increasing the correct answer rate of LLM response generation from original table data. In the case, the proxy table may serve as a passage for a user query. This may be utilized in the case of generating a response to the user query in an LLM 70 based on the table data.

According to an embodiment of FIG. 6, in operation S620, the data representation generation system may provide a predefined operation pool for various operations to generate a proxy table from table data. For example, functions included in the operation pool may include adding a column (F_add_col), selecting a specific row (F_select_row), selecting a column (F_select_col), and grouping (F_group_by, F_sort_by).

Afterwards, in operation S620, it may receive a user query. In operation S630, table data is found for enterprise documents highly relevant to a user query. However, a case may be considered where the table data does not include a correct answer to the user query. In this case, in operations S630 and s640, the table conversion data generator 350 in the data representation generation system of the present disclosure may select an operation so as to include a correct answer to the user query, and may generate a proxy table.

For example, a case may be considered where the user query of “Please tell me the sales amount for each of my company's products in 2024,” is received and table data in Table 1 is found from enterprise data.

TABLE 1

| | | | Quantity | Unit | Sales |
|---|---|---|---|---|---|
| Classification | Item | Vendor | sold | price | amount |
| Product name | A001 | Headquarter | 100 | $150 | — |
| Product name | A001 | Regional office | 120 | — | $18,000 |
| Product name | A002 | Headquarter | 200 | $200 | $40,000 |
| Product name | A002 | Regional office | [Omission] | $200 | $38,000 |
| Product name | A003 | Headquarter | 50 | — | $7,500 |
| Product name | A003 | Regional office | 75 | $100 | |

Because the table data in Table 1 doesn't include the answer to the user query, the table conversion data generator may first call a function of adding a column (F_add_col) from the operation pool, may add a total amount column to the table in Table 1, and may calculate the total sales amount generated by all vendors. Moreover, it may call a function of selecting a row (F_select_row) as the next operation from the operation pool and may select data for a specific product (A001). Furthermore, it may call a function of selecting a column (F_select_col) from the operation pool and may select only the column needed for analysis. In addition, it may call a grouping function (F_group_by), may perform grouping for each item, and may sum the total amount for each product. Finally, it may call a sorting function (F_sort_by), may sort the proxy table in descending order based on the total amount, and may display products from a product with the highest total amount first. Table 2 is an example of a proxy table generated by the table conversion data generator 350 according to the example above.

TABLE 2

| Classification | Item | Vendor | Total amount |
|---|---|---|---|
| Product name | A002 | Headquarter and regional office | $78,000 |
| Product name | A001 | Headquarter and regional office | $36,000 |
| Product name | A003 | Headquarter and regional office | $15,000 |

It may be seen that the proxy table illustrated in Table 2 includes the correct answer to the user query of “Tell me the sales amount for each of our products in 2024”.

Returning to the description of FIG. 6, in operation S660, the data representation generation system may deliver the proxy table being a passage, and the user query to the LLM 70 and may prompt the LLM 70 to generate a response.

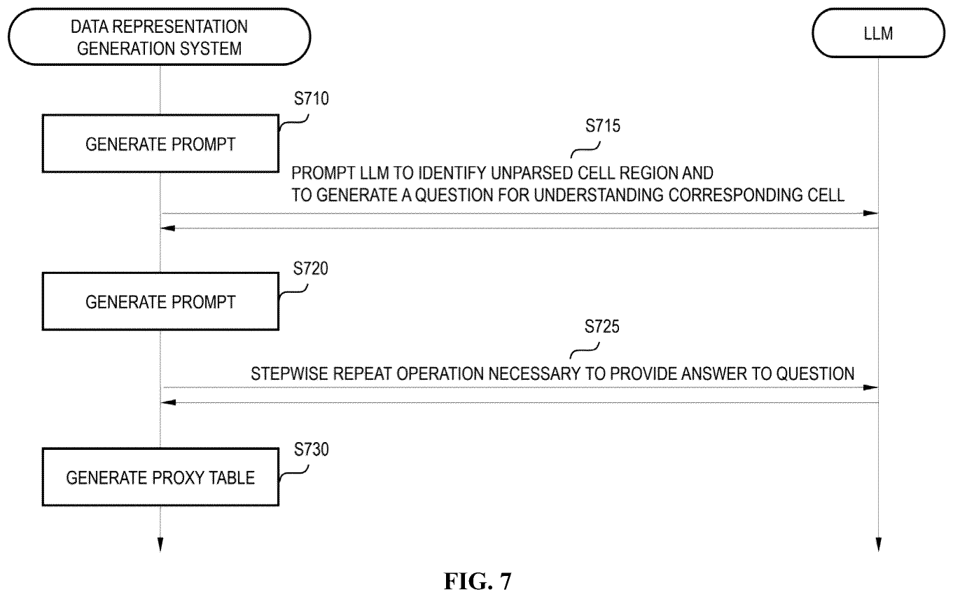

FIG. 7 is a flowchart illustrating a method for extracting conversion data from table data, according to another embodiment of the present disclosure.

A data representation generation system according to an embodiment of the present disclosure may generate a proxy table by converting table data such that there are no cells unparsed by prompting an LLM 70.

According to the embodiment of FIG. 7, in operations S710 and S715, when an enterprise document includes table data, the data representation generation system may prompt the LLM to generate a question for identifying an unparsed cell region and then understanding a cell.

Next, in operations S720 and S725, the data representation generation system may prompt the LLM to stepwise repeat an operation necessary to provide an answer to the question generated by the LLM.

After these two operations are performed, the LLM may generate a proxy table, and in operation S730, the data representation generation system may perform encoding after verifying the proxy table.

For example, when the table data in Table 3 below is included in enterprise data, the data representation generation system according to an embodiment of the present disclosure may deliver it to the LLM, and may prompt the LLM to generate a question for identifying an unparsed cell region and then understanding the corresponding cell. Moreover, the data representation generation system may generate a prompt to allow the LLM to stepwise perform an operation necessary to derive an appropriate answer for each question.

TABLE 3

| | | headquarter | Regional | Monthly sales | | |
|---|---|---|---|---|---|---|
| Classification | Item | manager | manager | volume | Sales amount | Remark |
| Product | A001 | Hong Gil- | — | January: 1200 | January: | Important |
| name | | dong | | February: 1100 | $15,000 | products |
| | | | | | February: | |
| | | | | | $14,000 | |
| Product | A002 | — | Yi Sun-sin, | January: 1300 | January: | |
| name | | | Park Cheol-su | February: | $16,500 | |
| | | | | [Omission] | February: | |
| | | | | | [$15,000] | |
| Product | A003 | Park Ji-sung | Kim Young- | January: 1400 | January: | |
| name | | | hee | February: 1500 | $17,000 | |
| | | | | | February: | |
| | | | | | $18,500 | |

The LLM needs to determine whether data in a monthly sales volume column in table data of Table 3 is not continuous, and the indicator of [Omission] is simply empty data, and may identify a cell having inconsistent currency notation in a sales amount column.

Afterwards, the LLM may generate appropriate questions for identifying the cell. For example, the LLM may generate questions such as [Question 1] “In the ‘Monthly sales volume’ column, may sales volumes for ‘January’ and ‘February’ be separated into individual rows?”, [Question 2] What does the difference between $15,000 and $15,000 in a brackets mean in the sales amount column? (Is it temporary data?), and [Question 3] How should we handle the “Important Product” information in the Remarks column?”.

Afterwards, the LLM may construct a proxy table by repeatedly performing operations for answering the question. The first operation is creating rows by dividing “Monthly sales volume” by month; the second operation is considering a value ([$15,000]) including brackets in the “Sales amount” column as temporary data and removing it from the “Sales amount” column, or adding a temporary indicator to a separate column; and the third operation is considering “Important product” information in the Remarks column as a product importance label and recording it in a new column.

Table 4 is an example of a proxy table generated by the LLM according to the example above.

TABLE 4

| | | | | Sales | Sales | Importance |
|---|---|---|---|---|---|---|
| Classification | Item | Manager | Month | volume | amount | level |
| Product name | A001 | Hong Gil- | January | 1200 | $15,000 | Importance |
| | | dong | | | | |
| Product name | A001 | Hong Gil- | February | 1100 | $14,000 | Importance |
| | | dong | | | | |
| Product name | A002 | Yi Sun-sin | January | 1300 | $16,500 | |
| Product name | A002 | Yi Sun-sin | February | Omission | $15,000 | |
| | | | | | (temporary) | |
| Product name | A003 | Park Ji-sung | January | 1400 | $17,000 | |
| Product name | A003 | Park Ji-sung | February | 1500 | $18,500 | |

It may be seen that in a proxy table shown in Table 4, each month is separated as an individual row by separating data in the monthly sales volume column and the sales amount column, a manager column is concisely written by integrating information about a headquarter manager and information about a regional manager, and “important product” information in the remarks is moved to a “importance level” column, and is added as a field indicating the importance level of the corresponding product. Moreover, it may be identified that the meaning of original data is maintained by specifying a temporary data notation as “$15,000 (temporary)”.

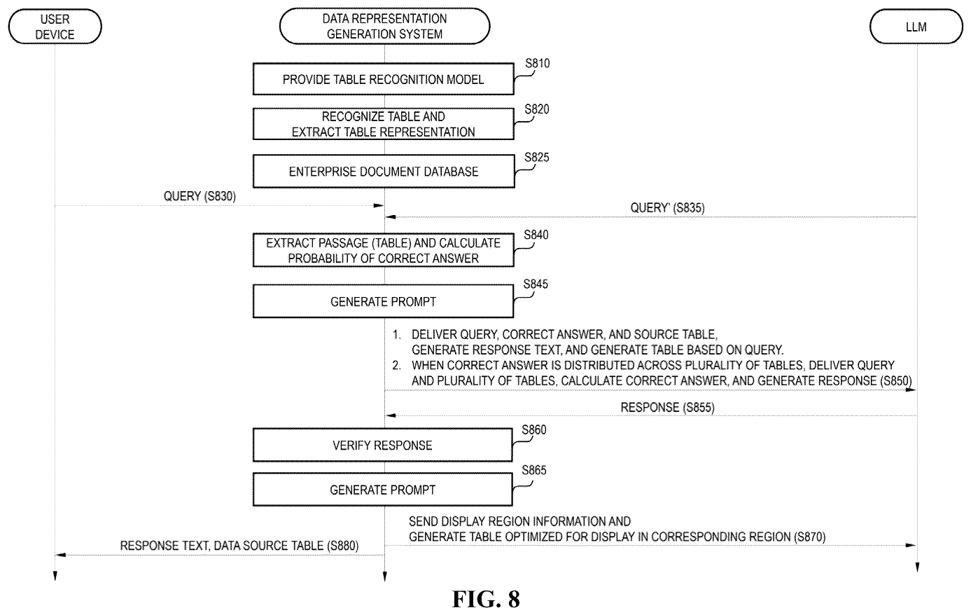

FIG. 8 is a flowchart illustrating an operation of recognizing table data and generating a response based on the table data, according to an embodiment of the present disclosure.

In operation S810, a data representation generation system may provide a table recognition model.

In more detail, the data representation generation system may build a large-scale learning dataset including various types of table structures and complex data to train a table recognition model. To this end, first, the data representation generation system may collect table data in various formats, and may tag structural features of each table (e.g., merged cells, multiple headers, nested tables, etc.) and formal features of data (date, currency, number, etc.) through a data preprocessing step. Afterwards, the data representation generation system may define the hierarchical structure and the relationships between pieces of data within the table by labeling the component of each table (cells, rows, columns, metadata, etc.).

Furthermore, the data representation generation system may set a task of predicting relationships between cells, whether cells are merged, and whether multiple headers are present, by converting table data collected in a training process of the table recognition model into a format that the model is capable of understanding. Furthermore, according to an embodiment of the present disclosure, a method for interpreting the meaning of unparsed cells in an LLM-based detailed question-response approach may be combined such that the model accurately understands complex table structures and correctly interprets data in various formats. Furthermore, an auxiliary learning process of generating a proxy table by using an operation pool may be additionally included.

In operation S820, when a table object is recognized in enterprise data, the data representation generation system may extract a table representation by applying the table recognition model. In the case, according to an embodiment of the present disclosure, the data representation generation system may generate conversion data such as a one-dimensional data representation or the proxy table to enhance the table data recognition rate of an LLM, and may extract a table representation through the conversion data. In operation S820, the generated table representation may be stored in an enterprise document database.

When a natural language query is received from a user device in operation S830, in operation S835, the data representation generation system may paraphrase the query such that it is suitable for retrieval and original intent is not changed, by prompting the LLM.

Afterwards, in operation S840, the data representation generation system may search for the enterprise document database based on the paraphrased query and may extract a passage highly relevant to the query. In the case, the data representation generation system may calculate the probability that the passage includes a correct answer.

In this case, it may consider a case where the passage extracted from the enterprise document includes the correct answer to the user query, or a case where the correct answer is distributed across a plurality of tables.

First, in operations S845 and S850, when the correct answer to the user query is clearly included in a single table, the data representation generation system may deliver the user query, the corresponding correct answer, and the related table to the LLM and may deliver, to the LLM, a prompt of “generate response text and sort and output the table based on the correct answer”. The LLM may generate a response sentence for the user query based the prompt and may provide the table in sorted form as necessary.

In this way, when the data generation representation system directly identifies the correct answer and the LLM only generates a response sentence, the internal system may already find and provide the correct answer, and thus the LLM may simply focus on generating sentences based on the correct answer without complex search or analysis tasks. This reduces the computational burden on the LLM, thereby accelerating response generation and reducing overall processing time. Furthermore, the correct answer may be already identified by the system, and thus the LLM is less likely to misinterpret the correct answer or to generate a response through uncertain inferences. Moreover, the LLM consumes significant computational resources. Accordingly, when the system extracts the correct answer in advance and uses them only for sentence generation, the computational resources of the LLM may be saved.

Meanwhile, when the correct answer is distributed across a plurality of tables, the data representation generation system may deliver a plurality of tables related to the user query to the LLM and may transmit a prompt of “calculate the correct answer with reference to each table and generate a response”. This prompt may guide the LLM to generate a final response by calculating and integrating necessary information from each table.

When the response generated by the LLM is received, in operation S860, the data representation generation system according to an embodiment of the present disclosure may verify the accuracy of the response and in operation S880, the data representation generation system may provide a user device with information about a table used as a data source, and a response.

In the meantime, in operations S865 and S870, the data representation generation system according to an additional embodiment of the present disclosure may prompt the LLM to generate a data source table optimized for a display of the corresponding region along with display region information of the user device, thereby enhancing user convenience.

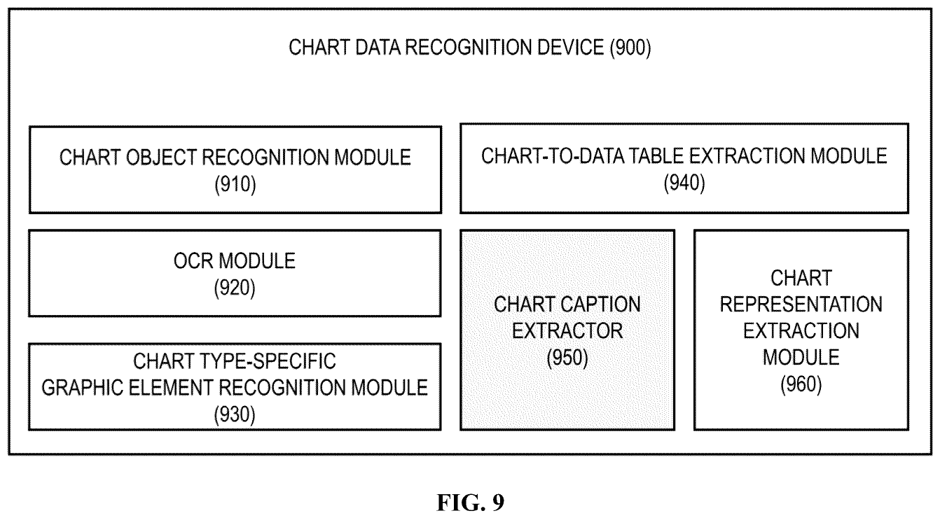

FIG. 9 is a structural diagram of a chart data recognition device, according to an embodiment of the present disclosure.

A chart data recognition device 900 according to an embodiment of the present disclosure effectively extracts meaningful information from chart data and provides a function for processing and interpreting a chart in conjunction with an LLM.

The chart data recognition device 900 of FIG. 9 is a device performing the function of the chart recognition module 34 of FIG. 1 and performs the function of recognizing various types of chart data acquired from the enterprise knowledge base 10 and converting them into vectors.

The chart data has a feature that expresses context and relationships between pieces of data by combining a visual element and text. A chart represents data by using various visual graphic elements, such as bars, lines, circles, and points. These graphic elements of the chart data represent specific values, categories, and time periods, thereby intuitively delivering data through visual structure. Furthermore, locations and sizes of components are important in the chart data. For example, in a bar chart, the height or location of a bar represents the size and category of a value; in a line chart, the height of a line represents a change over time; and, information about locations and sizes of objects in the chart data are important elements for representing relationships between data points.

However, the LLM is a model learned based on text, and thus the chart data may be less efficient than text data in the case where visual elements and location information are processed. The LLM may have a low chart data recognition rate because it is difficult to achieve sufficient performance in terms of differences in interpretation methods by chart type, understanding relationships between pieces of data, and understanding relationships between annotations and visual information. The present disclosure aims to address these issues.

The chart data recognition device 900 of FIG. 9 may improve the chart data recognition rate of the LLM through structural separation of visual elements, text information extraction, chart type-specific characteristic recognition, table conversion, summary caption generation, and data output in various formats. Each module assists the LLM in accurately grasping the visual data and structural meaning of the chart, and converts complex visual elements into text and structured data, thereby allowing the LLM to preform easier processing. In other words, the chart data recognition device in FIG. 9 performs a function of processing the chart data such that the LLM effectively understands and analyzes the chart data and extracting a chart representation.

In more detail, a chart object recognition module 910 in FIG. 9 recognizes the main components of the chart within the chart data. The chart object recognition module 910 is configured to identify and recognize each object constituting the chart, such as a chart region, an axis, a legend, and a data series. The chart object recognition module 910 may recognize structural elements of a chart by using a CNN-based object detection model, each component may be processed as an individual object with different features.

An OCR module 920 of FIG. 9 may perform OCR to extract text data within the chart. The OCR module 920 recognizes text information included in the chart, such as a chart title, an axis label, and a data value such that the text data is linked with a chart object.

A chart type-specific graphic element recognition module 930 in FIG. 9 performs a function of identifying values of graphic elements within a chart based on a chart type (e.g., a bar chart, a pie chart, a line chart, etc.) and collecting the location information. In this way, the chart type-specific graphic element recognition module 930 may effectively recognize the values and locations of data points according to a chart's visual characteristics, and may systematically organize chart data by identifying relationships between pieces of data.

The chart-to-data table extraction module 940 in FIG. 9 refers to a module that generates a data table based on the location information, and text and values extracted from the chart. Accordingly, by converting the chart data into a table format, data may be structured and stored for later data analysis or use in other modules within the system.

A chart caption extractor 950 in FIG. 9 refers to a module that automatically generates and extracts captions (annotation) for explaining the chart from the chart data. The chart caption extractor 950 summarizes main content of the chart and generates captions for explaining the meaning thereof, by analyzing visual elements and data included in the chart data. The captions provide context to the chart data, thereby helping users seeing the chart for the first time or the LLM quickly grasp key information of the chart.

The chart caption extractor 950 may generate a caption, which is obtained by summarizing the overall content of the chart, by analyzing a data type, a range, a trend, and key data points within the chart. For example, the chart caption extractor 950 may generate, as a caption, a description of “a bar chart shows monthly sales data for 2023 with the highest sales recorded in June”. For example, the chart caption extractor 950 may generate, as a caption, a description of “a linear chart shows the sales growth trend from 2018 to 2023 and having a steady upward trend”. For another example, the chart caption extractor 950 may generate, as a caption, a description of “a pie chart shows the proportion of total sales by segment in 2023, with the retail sales segment accounting for 45% of total sales”.

This caption condenses and expresses the main content and meaning of the chart, thereby helping the LLM easily understand the overall meaning of the chart data. This prevents the LLM from misinterpreting the chart's meaning or performing unnecessary calculations, and helps the LLM clearly understand the key points of the chart. Furthermore, a passage chart for a user query may be extracted by using caption data regarding the chart. In more detail, candidate chart data (passages) may be extracted based on the similarity between the user's query vector and the chart caption. For example, the chart with a caption highly similar to a user query may be extracted as a passage.

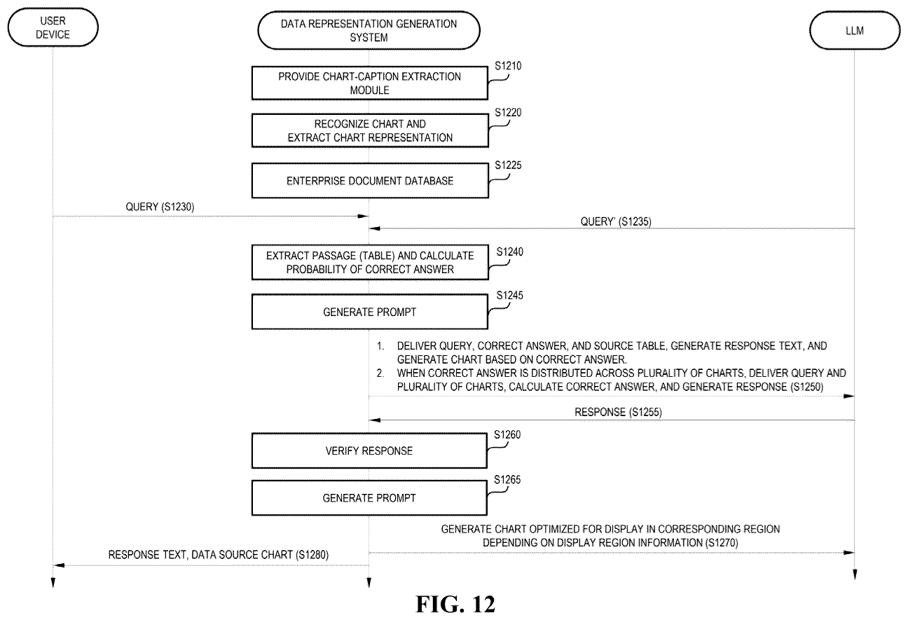

Specific operations of the chart caption extractor 950 according to an embodiment of the present disclosure are described later in the attached descriptions of FIGS. 11 and 12.

A chart representation extraction module 960 of FIG. 9 performs a function of outputting recognized chart data in various data formats, such as HTML, JSON, Markdown, and XML. This enables the chart data to be used in various applications or systems, thereby increasing the usability of chart data.

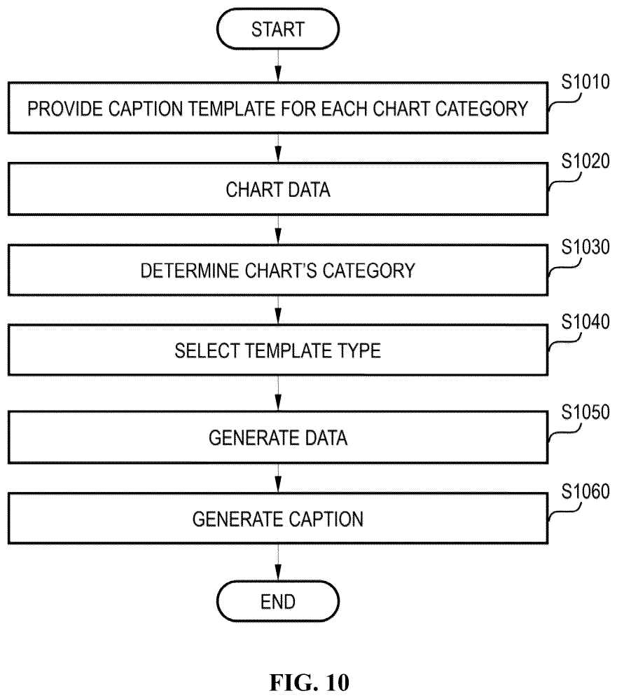

FIG. 10 is a flowchart illustrating a method for generating a caption from chart data, according to an embodiment of the present disclosure. According to the example in FIG. 10, a chart recognition server within a system may provide a predefined caption template for each chart category and may generate a caption for chart data by using the caption template.

In operation S1010, the chart recognition server may provide the caption template for each chart category. For example, the template may be defined for each chart type such as a bar chart, a line chart, a pie chart and a caption format suitable for the corresponding chart type may be provided. The template includes a phrase and a structure that summarize key information for each chart type.

In operation S1020, the chart recognition server may recognize components of the chart data and may recognize text by using an OCR.

In operation S1030, the chart recognition server may determine the chart's category based on the type and the field of the chart data. For example, when data shows trends over time, the chart recognition server may classify the data as a line chart. When data aims to compare categories, the chart recognition server may classify the data as a bar chart.

In operation S1040, the chart recognition server may select a template type suitable for the determined chart category. For example, when a chart shows sales trends by time period, the chart recognition server may select a template for emphasizing “changes by period”. The template type selection is based on key characteristics of the data, thereby supporting effective summarization of core content of the chart.

In operation S1050, the chart recognition server may generate data to be included in the caption by inserting the chart data into the template so as to be suitable therefor. In this case, the chart recognition server may simply organize core data of the chart by inserting specific data values (e.g., the highest point, the lowest point, a specific category value, etc.) into the chart based on the template structure.

In operation S1060, the chart recognition server may generate a final caption based on the generated data and the selected template. The caption is generated as a descriptive phrase for easily delivering the core content of the chart, by concisely summarizing main information of the chart. For example, a caption such as “the chart shows monthly sales data for 2023 with the highest sales recorded in June” may be generated. The chart generated through this process contributes to improving the chart recognition rate of the LLM by summarizing the core content of the chart data.

FIG. 11 is a flowchart for describing a method for extracting a caption from chart data, according to another embodiment of the present disclosure.

The example in FIG. 11 illustrates a method for generating a caption through a question-answering (QA) approach by using an LLM. A data representation generation system may prompt the LLM to identify key information in a chart and to generate a caption.

In more detail, in operation S1110, the data representation generation system may receive chart data. The data representation generation system identifies text, visual elements, and graphical information included in the chart, which serves as the basis for caption generation.

Next, in operations S1120 and S1125, the data representation generation system may generate a prompt for requesting the generation of a question-response (QA) set for the chart and may deliver the prompt to the LLM. Accordingly, the LLM may generate a query such as “When was the highest sales period?” and “When was the lowest sales period?” for a chart showing sales changes over time. Afterwards, the LLM may understand a key point of the chart data and may generate a response to the query based on the chart.

Next, in operations S1130 and S1135, the data representation generation system may generate a prompt for requesting the generation of a caption based on QA and may deliver the prompt to the LLM. Accordingly, the LLM may generate an overall summary of the chart by combining the previously generated QA set. For example, the LLM may generate a sentence obtained by summarizing the key content of the chart, such as “The chart shows monthly sales data for 2023 with the highest sales recorded in June”.

Next, in operation S1140, the data representation generation system may output the caption generated by the LLM together with the chart data as chart-caption data. The caption is generated based on questions and answers generated by the LLM, and thus is provided as a summary including the key information of the chart.

Afterwards, in operation S1150, candidate chart data (passages) may be extracted based on the similarity between the chart caption and the user's query vector. For example, the data representation generation system may extract the chart with caption data highly similar to the user query as a passage.

According to the embodiment of FIG. 11, key information about a chart may be analyzed in the form of questions and answers by using the LLM, and a caption may be generated based thereon. Accordingly, the LLM may automatically identify and summarize key points of the chart data, thereby generating an effective caption that easily conveys the meaning of the chart.

FIG. 12 is a flowchart illustrating an operation of recognizing chart data and generating a response based on the chart data, according to an embodiment of the present disclosure.

Referring to FIG. 12, a data representation generation system may recognize necessary information from chart data and may generate an appropriate response to a user's query by using an LLM.

In operation S1210, the data representation generation system may provide a chart-caption extraction module capable of analyzing the chart data and generating an appropriate caption. In a chart recognition server within a system, the chart-caption extraction module may be implemented by providing a predefined caption template for each chart category and generating a caption for chart data by using the caption template. Furthermore, according to another embodiment of the present disclosure, the chart-caption module may be implemented by generating a caption through a QA method using the LLM. Moreover, according to another embodiment of the present disclosure, the chart-caption module may be implemented in the form of an artificial intelligence model trained to summarize key information of the chart and to provide the summarized result in the form of a caption.

In operation S1220, the data representation generation system may recognize chart data through a chart recognition model and may extract visual and structural elements of the chart. In this process, the data representation generation system may convert important visual information, such as the chart's axes, legend, and data points, into text and structured data, and thus they may be used in a subsequent response generation process.

In operation S1225, the extracted representations associated with the chart data are stored in an enterprise document database. The database serves as a data source needed to generate a response to a user query. Besides, pieces of information related to the user query may be found and analyzed through the database where the chart data is stored.

When a natural language query is received from a user device in operation S1230, in operation S1235, the data representation generation system may paraphrase the query such that it is suitable for retrieval and original intent is not changed, by prompting the LLM. Afterwards, in operation S1240, the data representation generation system may search for the enterprise document database based on the paraphrased query and may extract a passage highly relevant to the query. In particular, according to an embodiment of the present disclosure, the passage may be extracted by using the similarity between a user query and a chart caption. That is, when the similarity between the user query and the chart caption is high, the chart data connected to a target caption may be extracted as a passage. Furthermore, the data representation generation system may calculate the probability that the passage includes a correct answer.

In this case, it may consider a case where the chart data being the passage extracted from the enterprise document includes the correct answer to the user query, or a case where the correct answer is distributed across pieces of chart data.

First, when the correct answer to the user query is clearly included in single chart data, in operations S1245 and S1250, the data representation generation system may deliver the user query, the corresponding correct answer, and the related chart to the LLM and may deliver, to the LLM, a prompt of “generate response text and reconstruct and output the chart based on the correct answer”. The LLM may generate a response sentence for the user query based thereon and may reconstruct and provide the chart as necessary.

In this way, when the data representation generation system directly identifies the correct answer and the LLM only generates a response sentence, the internal system may already find and provide the correct answer, and thus the LLM may simply focus on generating sentences based on the correct answer without complex search or analysis tasks. This reduces the computational burden on the LLM, thereby accelerating response generation and reducing overall processing time. Furthermore, the correct answer may be already identified by the system, and thus the LLM is less likely to misinterpret the correct answer or to generate a response through uncertain inferences. Moreover, the LLM consumes significant computational resources. Accordingly, when the system extracts the correct answer in advance and uses them only for sentence generation, the computational resources of the LLM may be saved.

Meanwhile, when the correct answer is distributed across a plurality of charts, the data representation generation system may deliver a plurality of charts related to the user query to the LLM and may transmit a prompt of “calculate the correct answer with reference to each chart and generate a response”. This prompt may guide the LLM to generate a final response by calculating and integrating necessary information from each chart.

In operation S1255, the data representation generation system may receive the response generated by the LLM In operation S1260, the data representation generation system may verify the accuracy of the response. In operation S1280, the data representation generation system may provide a user device with information about a chart used as a data source, and a response.

In the meantime, the data representation generation system according to an additional embodiment of the present disclosure may prompt, in operations S1265 and S1270, the LLM to generate a data source chart optimized for a display of the corresponding region along with display region information of the user device, thereby enhancing user convenience.

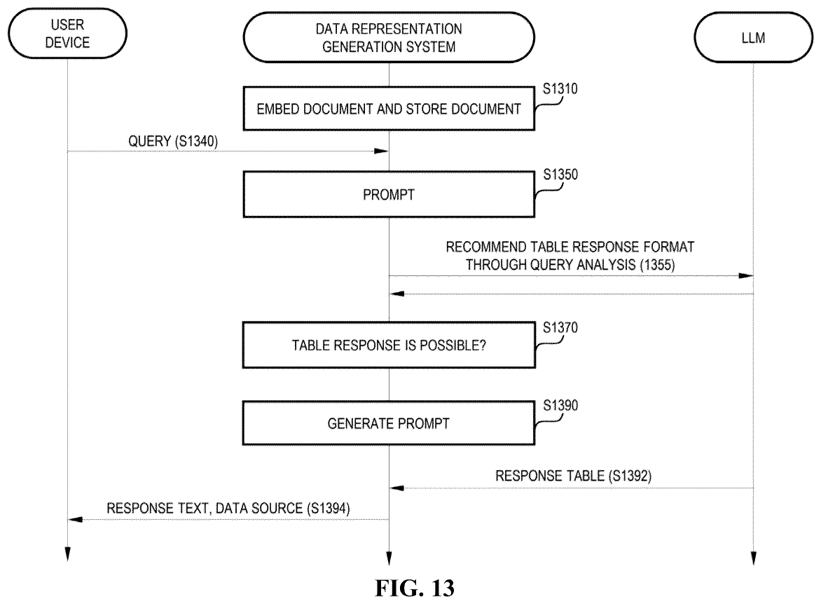

FIG. 13 is a flowchart for describing a method for generating table data, according to an embodiment of the present disclosure.

In operation S1310, a data representation generation system according to an embodiment of the present disclosure may embed an enterprise document, store the embedded enterprise document, and generate a database.

In operation S1340, the data representation generation system according to an embodiment of the present disclosure may receive a query from an enterprise user. The user query may be received in natural language through a question-and-answer application installed on a user device. The natural language query may be applied to an embedding model and may be expressed as a query vector.

In operation S1350 and S1355, the data representation generation system according to an embodiment of the present disclosure may generate a prompt for requesting a response format recommendation from a user query and may deliver the prompt to an LLM. Accordingly, the LLM may reference the intent of the user query. When the intent of the user query includes a response in the form of a graph representation, the LLM may recommend a format of a response table, such as a column header, that reflects the intent.

For example, when the user query is “Compare the sales growth rates of departments over the past five years,” the LLM may recommend a table response of a format having <Year-Department-Sales Growth Rate> as a column head. For another example, when the user query is “Show customer satisfaction evaluation results for each branch over the past three years,” the LLM may recommend a table response of a format having <Year-First Branch Satisfaction-Second Branch Satisfaction-Third Branch Satisfaction> as a column head.

In operation S1370, the data representation generation system according to an embodiment of the present disclosure may determine whether it is possible to generate a table in the recommended format, based on enterprise data. In more detail, the data representation generation system may create a query for filling a table cell in the recommended format with reference to the recommended response format and may determine the possibility of a table response based on whether the correct answer thereto is extracted as a passage from the enterprise data.

When it is possible, in operation S1390, the data representation generation system may prompt the LLM to generate a response table in the recommended format. In this case, the data representation generation system may also deliver the passage extracted together in operation S1370.

In operation S1392, the data representation generation system may receive the response table from the LLM. Further, the data representation generation system may verify the response table. The response table may be provided through a question-and-answer application installed on the user device. In operation S1394, the data representation generation system may provide the response table along with a data source formed the basis for generating the response.

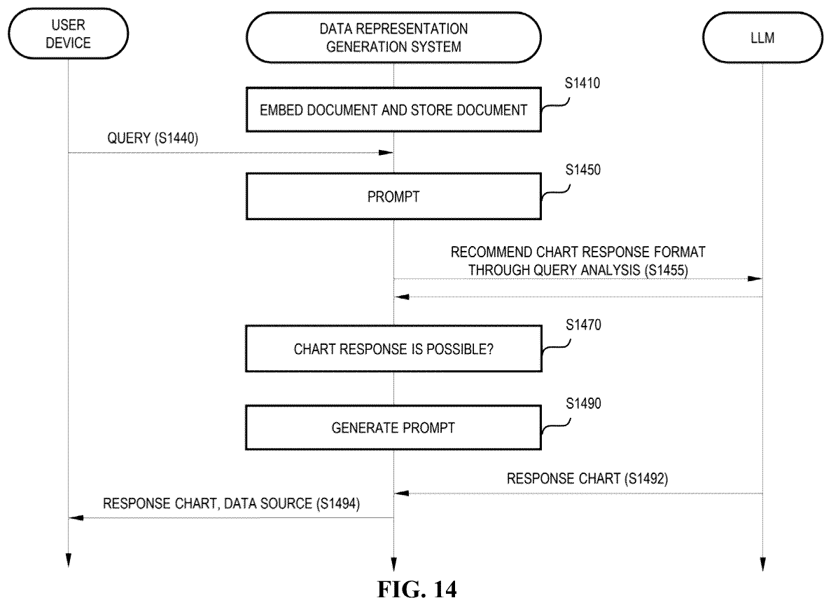

FIG. 14 is a flowchart for describing a method for generating chart data, according to an embodiment of the present disclosure.

In operation S1410, a data representation generation system according to an embodiment of the present disclosure may embed an enterprise document, store the embedded enterprise document, and generate a database.

In operation S1440, the data representation generation system according to an embodiment of the present disclosure may receive a query from an enterprise user. The user query may be received in natural language through a question-and-answer application installed on a user device. The natural language query may be applied to an embedding model and may be expressed as a query vector.

In operation S1450 and S1455, the data representation generation system according to an embodiment of the present disclosure may generate a prompt for requesting a response format recommendation from a user query and may deliver the prompt to an LLM. Accordingly, the LLM may reference the intent of the user query. When the intent of the user query includes a response in the form of a chart representation, the LLM may recommend a format of a response chart, such as a chart type and a chart field, that reflects the intent.

The user query including the intent of chart representation may be effectively answered by visually expressing trends, comparisons, ratios, and distributions of data. It is appropriate for users to intuitively understand the data through a chart response.

For example, when the user query is “Compare the number of quarterly customer inflows over the past three years”, the LLM may recommend the chart response in the format of <chart type: Clustered Bar Chart, chart field X-axis: Quarter, Y-axis: Number of customer inflows, color distinction: Year>. For another example, when the user query is “Visually show monthly sales changes for each branch,” the LLM may recommend the chart response of a format of <chart type: Multi-Line Chart, chart X-axis: Month, Y-axis: Sales, line distinction: Branch>.

In operation S1470, the data representation generation system according to an embodiment of the present disclosure may determine whether it is possible to generate a chart in the recommended format, based on enterprise data. In more detail, the data representation generation system may create a query for generating a chart in the recommended format with reference to the recommended response format and may determine the possibility of a chart response based on whether the correct answer thereto is extracted as a passage from the enterprise data.

When it is possible, in operation S1490, the data representation generation system may prompt the LLM to generate a response chart in the recommended format. In this case, the data representation generation system may also deliver the passage extracted together in operation S1470.

In operation S1492, the data representation generation system may receive the response chart from the LLM. Further, data representation generation system may verify the response chart. The response chart may be provided through a question-and-answer application installed on a the user device. In operation S1394, the data representation generation system may provide the response chart along with a data source formed the basis for generating the response.

According to an embodiment of the present disclosure, a method and a system for generating data representations based on an LLM may recognize unstructured data within a document by using the LLM and may generate data representations such as tables and/or charts based on the document.

According to an embodiment of the present disclosure, the method and the system for generating data representations based on the LLM may enhance the accuracy of recognition and inference of unstructured data of a company in the LLM. According to an embodiment of the present disclosure, the method and

the system for generating data representations based on the LLM may generate a data representation in the form of a table or a chart that reflects the intent of a query of an enterprise user.

According to an embodiment of the present disclosure, the method and the system for generating data representations based on the LLM may increase the accuracy of a response of sLLM for enterprises and may simultaneously ensure data reliability for the response by separating a process of recommending a format for a visualization response based on intent analysis of a natural language query and a process of determining whether individual data cells of the recommended format are capable of being filled based on an understanding of enterprise data.

According to an embodiment of the present disclosure, the method and the system for generating data representations based on the LLM may calculate the enterprise data to generate the required values for data cells, and thus may enhance inference and decision-making support functions of the enterprise sLLM service, when individual data cells of the recommended format are incapable of being filled from the enterprise data.

According to an embodiment of the present disclosure, the method and the system for generating data representations based on the LLM may determine whether a format of a visualization response of intent queried by a user is capable of being generated, based on the enterprise data, thereby improving the efficiency and quality of sLLM system operation.

According to an embodiment of the present disclosure, the method and the system for generating data representations based on the LLM may strengthen the business intelligence function of a sLLM service because a response according to the intent of a user query is provided based on the enterprise data.

Effects of the present disclosure are not limited to the above-described effects, and any other effects not mentioned herein may be clearly understood from this specification and the accompanying drawings by those skilled in the art to which the present disclosure pertains.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method for providing a response to a user query based on a large language model (LLM) in a server, the method comprising:
storing user data in a data storage module;
analyzing intent of a natural language query when receiving the natural language query from a user;
making a request for a format of a table and/or a chart according to the intent of the natural language query to the LLM when the intent of the natural language query includes a response in a form of the table and/or the chart;
determining whether a response in a form of a table and/or a chart is possible, based on whether data required from the format is capable of being found from the user data or is capable of being computed from the user data;
when the response is possible, generating, by the LLM, a response to the natural language query in the form of the table and/or the chart based on the user data; and
providing the user with the data as a data source together with the response, and
wherein the making of the request for the format of the table and/or the chart according to the intent of the natural language query to the LLM includes:
expanding the natural language query from the user based on paraphrasing by applying rule-based paraphrasing and LLM-based paraphrasing in a hybrid method;
performing preprocessing by tokenizing the user query expanded based on the paraphrasing into individual words or morphemes and normalizing the individual words or the morphemes; performing analysis of a key word and a sentence structure on the preprocessing result to determine one of a table, a chart, and general text as a response format for the natural language query; and
requesting the format of the table and/or the chart according to the determined response format.

2. The method of claim 1, wherein the generating includes:
requesting the LLM to generate a response together with data related to the query and the format of the table and/or the chart.

3. The method of claim 1, wherein the providing includes:
assigning a response region, a data source region, and a modification request region for the response to a display of the user.

4. The method of claim 1, further comprising:
reflecting a change request for one or more of a field, a scale, and a format of the table and/or the chart received from the user.

5. A device providing a response to a user query based on a large language model (LLM), the device comprising:
a data storage unit configured to store user data;
a communication unit configured to communicate with a user device;
a control unit configured to analyze intent of a natural language query when receiving the natural language query from a user, to make a request for a format of a table and/or a chart according to the intent of the natural language query to the LLM when the intent of the natural language query includes a response in a form of the table and/or the chart, and to determine whether a response in a form of a table and/or a chart is possible, based on whether data required from the format is capable of being found from the user data or is capable of being computed from the user data; and
the LLM configured to generate a response to the natural language query in the form of the table and/or the chart based on the user data,
wherein the control unit provides the user with the data as a data source together with the response, and
wherein the control unit is configured to:
expand the natural language query from the user based on paraphrasing by applying rule-based paraphrasing and LLM-based paraphrasing in a hybrid method to the intent of the natural language query;
perform preprocessing by tokenizing the user query expanded based on the paraphrasing into individual words or morphemes, and normalizing the individual words or the morphemes;
perform analysis of a key word and a sentence structure on the preprocessing result to determine one of a table, a chart, and general text as a response format for the natural language query; and
request the format of the table and/or the chart according to the determined response format.

6. A non-transitory computer-readable recording medium storing a computer program for performing the method of claim 1 in combination with hardware.
